(19) United States
(12) Patent Application Publication
(10) Pub. No.: US 2021/0034226 A1
(43) Pub. Date: Feb. 4, 2021

(54) COMPUTING DEVICE FOR LOGGING CHANGES IN A PERSON'S MOOD OVER TIME

(71) Applicant: Babylon Partners Limited, London (GB)

(72) Inventors: Alessandro Rodolfo GUAZZI, London (GB); Adrian Lopez HERNANDEZ, London (GB); Kate LOGAN, London (GB); Levi Bryce EPSTEIN, London (GB); Rama NALLAMILLI, London (GB); Nima MONTAZERI, London (GB); Mohammad KHODADADI, London (GB); Chung Ho HA, London (GB)

(21) Appl. No.: 16/537,306

(22) Filed: Aug. 9, 2019

(30) Foreign Application Priority Data
Aug. 2, 2019 (GB) 1911098.0

(51) Int. Cl. G06F 3/0484; G06F 3/0488; G06F 3/0481; G06F 9/451; G06F 16/2458

(52) U.S. Cl. CPC G06F 3/04847; G06F 3/04883; G06F 16/2477; G06F 9/451; G06F 3/0481

(57) ABSTRACT

A computing device for logging changes in a person's mood over time, the device comprising a user interface for receiving a user-input selecting one of a plurality of mood descriptors indicative of the user's mood at a current point in time, a processor configured to determine a pair of values associated with the selected mood descriptor, wherein a first value in the pair of values defines a position on a first mood axis and the second value in the pair defines a position on a second mood axis, the first and second mood axes being associated with different aspects of mood, a memory for storing the pair of values together with an indicator of the current point in time, the processor being further configured to compare the pair of values with one or more other pairs of values obtained at respective points in time, thereby to generate trend date reflecting one or more trends in the values over time.

### CROSS-REFERENCE TO RELATED APPLICATION

This application claims priority to GB1911098.0, filed Aug. 2, 2019, the contents of which are hereby incorporated by reference in its entirety.

### FIELD

Embodiments described herein relate to a computing device for logging changes in a person's mood over time.

### BACKGROUND

Mood is a psychological state distinct from emotion or affect in that it has a longer duration and/or does not have an origin that is clear to the person experiencing it. Here, the term “affect” can be understood to refer to the external and dynamic manifestations of a person's internal emotional state, whilst a person's mood refers to their predominant internal state at any one time (see “The Psychiatric Mental Status Examination”, Trzepacz and Baker, 1993). A temporal relationship between affect, mood and temperament is discussed in a paper by Malhi G S, Hamilton A, Morris G, Mannie Z, Das P, and Outhred T (see “The promise of digital mood tracking technologies: are we heading on the right track?” in Evid Based Ment Health. 2017 November 20(4): p 102-107). As discussed in the paper, momentary changes in affect occur over a timescale of seconds and minutes, whilst mood is a more prolonged emotional state that can vary over hours and days. A person's temperament is relatively stable over time, with modulations occurring over years and decades.

The measurement of mood is particularly relevant to health as it defines a number of conditions known as mood disorders, including bipolar disorder and mania, for example. Mood instability is furthermore present in a large portion of the population (over 13%, particularly prominent amongst women and in younger and working-age adults) and is associated with the development of mood disorders as well as co-occurring with common mental conditions. For this reason, tracking a person's mood over time is an important part of identifying trends that could contribute to the person developing such conditions later on. Tracking a person's mood can help to give people insights into their mental health and understand their overall mental lives in more detail. It can help people to understand what impact different situations, people, and other factors have on their mood. There is also a clinical value: keeping a record of mood can provide valuable data for clinicians, allowing them to piece together a detailed history that can support diagnosis and ongoing care.

However, conventional means for tracking a person's mood have not always proved effective. Among the problems encountered with conventional means are that a person, when asked to define their mood, may not be able to easily express how they feel, or may not be able to do so in sufficiently specific terms (for example, they may initially say they are “discontent” but, when questioned further, may decide that “sad” is a more accurate description). Another problem is that conventional devices for tracking a user's mood only consider a single, emotional dimension—how happy or sad a person feels, for example. However, simply stating that one is “unhappy” or “low-spirited” can only give a limited insight into the person's state of mind. More generally, conventional tracking methods rely on the user keeping a diary of their mood changes, which they update once a day or possibly less frequently (e.g., twice a week). However, doing so has the drawback that the user's recollection of precisely how they felt at an earlier point in the day or week is often inaccurate. For this reason, it is preferable to record the person's mood more frequently and as close as possible to “real-time”, but users can find it impractical carry a diary or journal around with them and update it with the necessary level of frequency.

### SUMMARY

According to a first aspect of the present disclosure, there is provided a computing device for logging changes in a person's mood over time, the device including: a user interface for receiving a user-input selecting one of a plurality of mood descriptors indicative of the user's mood at a current point in time; a processor configured to determine a pair of values associated with the selected mood descriptor, wherein a first value in the pair of values defines a position on a first mood axis, and the second value in the pair defines a position on a second mood axis, the first and second mood axes being associated with different aspects of mood; and a memory for storing the pair of values together with an indicator of the current point in time. The processor is further configured to compare the pair of values with one or more other pairs of values obtained at respective points in time, thereby to generate trend date reflecting one or more trends in the values over time.

The first mood axis may define a level of energy associated with the selected mood descriptor. The second mood axis may define a level of positivity associated with the selected mood descriptor. For each pair of values, the processor may be configured to determine if one or both of the values lie above or below a respective threshold. The computing device may be configured to transmit the trend data to a remote device or server.

The user interface may include a control panel for navigating to different regions of a mood chart. The mood chart may include a plurality of mood descriptors arranged in a spatial layout, each mood descriptor representing a different mood that a user may be experiencing at a particular point in time. The mood descriptors in the mood chart may be arranged such that navigating in a first direction in the mood chart causes the user to move along the first mood axis and navigating in a second direction in the mood chart causes the user to move along the second mood axis. In some embodiments, as the user navigates the mood chart, the user interface is configured to display a subgroup of the mood descriptors from the mood chart. The subgroup of mood descriptors may include one or more mood descriptors associated with the region of the mood chart to which the user has currently navigated. The subgroup of mood descriptors may include a single mood descriptor only. The single mood descriptor may be the only part of the mood chart that is displayed in the user interface. The single mood descriptor may be displayed as a title in the user interface. The control panel may include a defined area of the user interface, the user being able to select different points from within the area of the control panel. The user device may be configured to perform a mapping between points within the area and positions on the mood chart so as to map the selected position within the area to a position on the mood chart. The control panel may be displayed on a screen of the computing device, the device being configured to display a marker at the point in the area selected by the user. The user interface may include a touch screen. The user may be able to select different points within the area by touch. The marker may be colour-coded based on the mood descriptor(s) associated with the position on the mood chart to which the selected point is mapped. The marker may include an inner section and an outer surround, the outer surround being colour-coded based on the mood descriptor associated with the position on the mood chart to which the selected point is mapped. In the event the user chooses to log in memory the mood descriptor that is associated with the position on the mood chart to which the selected point in the control panel is mapped, the user device may be configured to colour the inner section of the marker with the colour of the outer surround.

The mood chart may be a circular wheel. The wheel may include a plurality of annular rings, each ring having one or more annular sectors, each mood descriptor being located in a respective one of the annular sectors. The processor may be configured to determine the pair of values associated with the selected mood descriptor by determining a set of polar or Cartesian coordinates for the position of the mood descriptor on the mood chart.

The computing device may be configured to store additional media content in association with the selected mood descriptor. The additional media content may include one or more of: notes, images, videos and audio clips provided by the user. The computing device may be configured to display, within the area of the control panel, one or more markers indicative of mood descriptor(s) that have previously been selected by the user. Each of the one or more markers may be located at a position corresponding to a mood descriptor that has previously been selected by the user. The computing device may be configured to display the one or more markers in a sequence, in the order in which the corresponding mood descriptors were selected by the user.

The computing device may be configured to only display the markers that correspond to mood descriptors that have been selected within a specified time window. In some embodiments, the user may be able to define the time window. The user may further be able to scroll through time by moving the time window. When displaying the one or more markers in a given time window, each marker may include an indication of the number of times the mood descriptor corresponding to that marker has been selected within the time window. Alternatively, or in addition, each of the one or more markers may be sized according to how recently the mood descriptor corresponding to the respective marker was selected. The one or more markers may have different colours and/or degrees of transparency that correspond to how recently the respective mood descriptors were selected. As a result of the user scrolling through time, markers displayed within the area of the control panel may become smaller or fainter, as they become “older” selections relative to other markers that correspond to mood descriptors that have more recently been selected by the user.

According to a second aspect of the present disclosure, there is provided a computer-implemented method for logging changes in a person's mood over time, the method including: receiving a user-input selecting one of a plurality of mood descriptors indicative of the user's mood at a current point in time; determining a pair of values associated with the selected mood descriptor, wherein a first value in the pair of values defines a position on a first mood axis, and the second value in the pair defines a position on a second mood axis, the first and second mood axes being associated with different aspects of mood; storing the pair of values together with an indicator of the current point in time; and comparing the pair of values with one or more other pairs of values obtained at other points in time, thereby to determine trend date reflecting one or more trends in the values over time.

According to a third aspect of the present disclosure, there is provided a non-transitory computer-readable storage medium including computer executable instructions that when executed by a computer will cause the computer to carry out a method according to the second aspect of the present disclosure.

### BRIEF DESCRIPTION OF DRAWINGS

Embodiments of the disclosure will now be described by way of example with reference to the accompanying drawings in which:

FIG. 1 shows an example of a user device according to an embodiment described herein;

FIG. 2 shows an example of a mood chart according to an embodiment described herein;

FIGS. 3 to 6 show examples of how a user may move a marker within an area of a control panel in order to identify a mood descriptor that best describes their current mood;

FIG. 7 shows percentage markings on a mood axis of a mood chart according to an embodiment;

FIG. 8 shows a table of percentage scores associated with different mood descriptors on first and second mood axes of a mood chart according to an embodiment;

FIG. 9 shows the indices for each mood descriptor in FIG. 8 as they appear in the mood chart;

FIG. 10 shows an example display in a user interface of a computing device according to an embodiment;

FIG. 11 shows an example display in a user interface of a computing device according to an embodiment;

FIG. 12 shows an example display in a user interface of a computing device according to an embodiment;

FIG. 13 shows an example display of trend data displayed in a user interface of a clinician's computing device; and

FIG. 14 shows a flow-chart of steps carried out in a method according to an embodiment.

### DETAILED DESCRIPTION

It is desirable to provide a simplified means by which a user can log their mood, and which can allow further insight into any underlying trends in the user's mood over time.

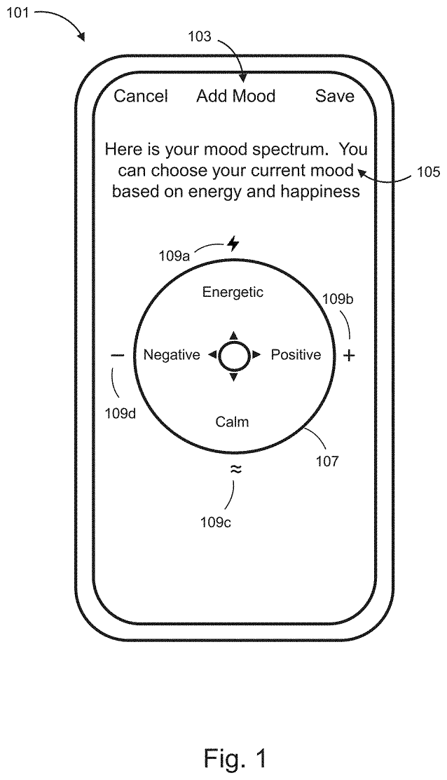

FIG. 1 shows an example of a computing device 101 for logging changes in a person's mood over time, in accordance with an embodiment. The device may be any personal computing device and will typically be a mobile computing device such as a mobile phone, smartphone, laptop computer or personal organiser, for example. The device has a screen that can be used to display information. The screen may be a touch screen, for example.

The device can be used to open an application that will allow the user to store a record of their mood at a particular point in time. FIG. 1 shows an example view on the screen as might be displayed when the application is opened. The screen includes an options bar 103, from which the user can select the option to search for a mood suggestion (“Add mood”). The options bar also includes an option to log a particular mood (“Save”) and a further option to cancel the current session (“Cancel”). Also shown on the screen is an indicator bar 105 that can be used to display information to the user. Towards the centre of the display is a control panel 107 by means of which the user can search for and select a mood descriptor to be stored in memory as a record of their mood at the present point in time.

Conventional devices for tracking a user's mood consider a single, emotional dimension—how happy or sad a person feels, for example. In contrast, the computing device of FIG. 1 assesses mood as a combination of this emotional dimension with another, more physical, dimension, such as how energising or activating the mood is (as an example, one can consider a nervous mood as having a physical component in the form of the person being more jittery). In the present embodiment, the first dimension or “mood axis” can be defined as “positivity”, i.e. how agreeable or pleasant the person's mood is, from sad to happy. The second dimension (or mood axis) can be defined as “energy”, i.e. where the body's level of response is, from feeling calm and still to active and alert. Together, these two mood axes define a two-dimensional space in which different moods are located at different coordinate points. For example, a person who is excited may have an agreeable emotional response (high on the positivity axis) and an alert physical response (high on the energy axis). Conversely, a person who is bored may have an unpleasant emotional response (low on the positivity axis) and will also not be feeling active or alert (low on the energy axis). In another example, a person who is feeling serene would have an agreeable emotional response (high on the positivity axis) but not be particularly energetic (low on the energy axis).

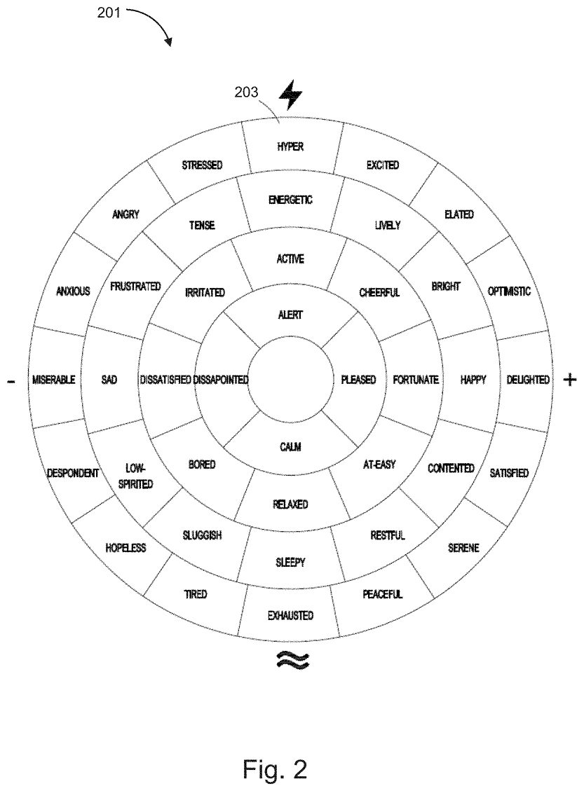

The computing device 101 is configured to determine a point in the two-dimensional space that is associated with the user's current mood and, in turn, to resolve the mood into a pair of values that reflect the distances along the respective mood axes. The computing device achieves this by use of a mood chart, an example of which is shown in FIG. 2. In this example, the mood chart 201 takes the form of a wheel comprising a series of concentric circles, which together form a set of annular rings of different radii. Each annular ring is split into a number of annular sectors 203 with each annular sector having its own unique mood descriptor. In the present example, each mood descriptor is a word defining a particular mood or emotion, such as “happy”, “sad”, “bored”, “alert”, etc. The mood chart may be stored locally in memory on the user device or, alternatively, may be downloaded from a remote server via a wireless communication link, for example.

The mood descriptors are arranged in the chart in a particular spatial layout. Specifically, the mood descriptors are arranged such that as one navigates horizontally from left to right across the chart, one moves along the “positivity” mood axis in the direction from negative to positive, and if one navigates vertically from the bottom to the top of the chart, one moves along the “energy” axis in the direction from calm to active. It will be appreciated that, as a result of this layout, the mood descriptors in each successive ring become gradually more intense. As an example, if one moves radially outwards to the left of centre, one passes the mood descriptor “disappointed” before encountering “dissatisfied”, “sad” and finally “miserable”. Each of these four mood descriptors can be considered “negative” but with an increase in intensity as one moves away from the centre of the wheel. Taking the centre of the chart to be the origin of the two-dimensional space, each mood descriptor in the chart has an associated pair of coordinates in the two-dimensional space that reflect the position of that mood along the two mood axes.

Referring once more to FIG. 1, the computing device 101 allows the user to navigate the mood chart and select a mood descriptor that reflects their current mood by using the control panel 107. The amount of information contained within the mood chart may be larger than that which can be easily displayed on the screen of a user device; indeed, depending on the size of the user device, if all the information contained in the mood chart were to be displayed at once, the mood descriptors would likely be too small to read. In addition, a user may be simply overwhelmed by the amount of information depicted on the screen and may be put off using the application. The latter point may be a particular issue for those most in need of the application to record their mood and who may have a predisposition to “give up” on logging their mood data if confronted with what seems like too challenging a task. In order to solve this problem, when navigating around the mood chart, the chart itself is not displayed on the screen; instead, the user is able to navigate around the mood chart by moving the position of a marker within the area defined by the control panel 107. A mapping is provided between the area of the circle 107 and the mood chart, such that for any position of the marker, a corresponding position on the mood chart can be identified. To aid the user in moving the marker, the control panel includes icons 109a, 109b, 109c, and 109d that are each associated with a particular direction of motion on the control panel. The upwards direction is associated with the feeling “energetic”, the downwards direction is associated with the term “calm” and the left and right directions are associated with the feelings “negative” and “positive”, respectively. In this way, the icons reflect the layout of the mood descriptors in the mood chart.

A user may move the marker to a particular point within the circle 107 by placing their finger on the screen at that point. The user device determines the coordinates of the point of contact and maps this to a point on the mood chart. The user device in turn determines the mood descriptor associated with the particular point on the chart and displays this in the indicator bar on the user interface. Thus, as the user moves their finger around within the circle 107, the position of the marker within the circle changes and different mood indicators are displayed, depending on the particular point in the circle with which the user's finger is in contact. In this way, the user is able to easily and intuitively navigate the mood chart, without the chart itself needing to be displayed on the screen.

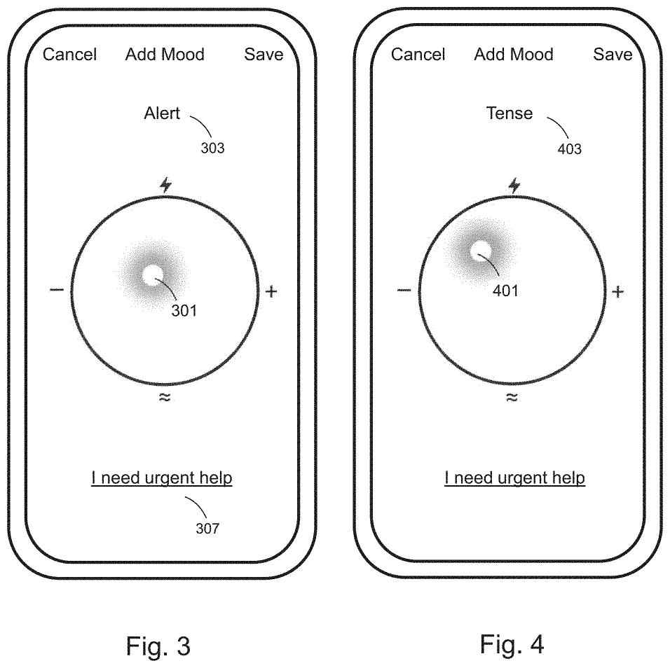

FIGS. 3 to 6 show examples of how the user may move the marker within the area of the control panel in order to identify a mood descriptor that best describes their current mood. Referring to FIG. 3, the marker takes the form of a smaller circle 301, surrounded by a halo, which might take a particular colour depending on the mood associated with the marker's current position. In FIG. 3, the marker is located slightly upwards and left of centre of the circle and is mapped to the annular sector associated with the mood descriptor “alert” in the mood chart. As a result, the word “Alert” is presented in the indicator bar above the control panel. FIG. 4 shows the case in which the user, having first been presented by the term “Alert”, decides that the term does not quite capture what they are feeling; instead, the user feels more energetic, but also somewhat negative, and accordingly has moved the marker both upwards and to the left in the control panel, for example by dragging the marker across the screen. The marker's position in FIG. 4 is mapped to the annular sector of the mood chart that is associated with the mood descriptor “tense”; accordingly, the term “Alert” as shown in the indicator bar of FIG. 3 is now replaced by the term “Tense”.

Also shown in FIGS. 3 and 4 is a “Help Request” 307 that a user may select if they feel in urgent need of help, possibly because they in a highly emotional state and require some form of intervention from, e.g. a friend, family member, or health care professional. The Help Request may open a link to a website at which the user can post a message or may initiate a phone call to a predetermined number where they can receive counseling, for example.

FIG. 5 shows another example in which the user has positioned the marker 501 at a point that maps to the annular sector of the mood chart associated with the mood descriptor “restful”. Accordingly, the term “Restful” now appears in the indicator bar 503. FIG. 6 shows the appearance of the user interface after the user has decided they are actually feeling considerably more negative and have moved the marker 601 towards the other side of the circle, in the “negative” direction. As a result, the marker's position in FIG. 6 now maps to the annular sector of the mood chart associated with the mood descriptor “sluggish”, with the term “Sluggish” now replacing the term “Restful” in the indicator bar 603.

It can be seen that the arrangement of mood descriptors in the mood chart, together with the mapping between the control panel and the mood chart, can allow a user to easily search for and identify an appropriate descriptor of their current mood, without necessarily being able to think of the descriptor until they see it presented on the screen of the user device. As an example, a user may initially not think of describing themselves as “serene” but may start by identifying themselves as feeling more “calm” than “energetic” or “negative” and so begin moving the marker downwards in the control panel area. As they do so, they will encounter the terms “relaxed” and “sleepy” and may determine that these terms do not appropriately describe their mood as the terms are somewhat neutral when the user is, in fact, feeling more pleased than they'd first considered. The realisation may prompt the user to move the marker in the “positive” direction, at which point, they will start to encounter the terms “restful”, “peaceful” and “serene”. The user may then decide that “serene” in the mood descriptor that best captures their current feelings.

Having arrived at a mood descriptor that accurately conveys their feelings, the user may log their mood by pressing “Save” on the Options bar. When doing so, the user device stores a record of the time at which the user logged their mood. At this point, the computing device uses the position of the selected mood descriptor to determine a pair of values in the two-dimensional coordinate space that reflect the user's position on the respective mood axes and logs these values in memory.

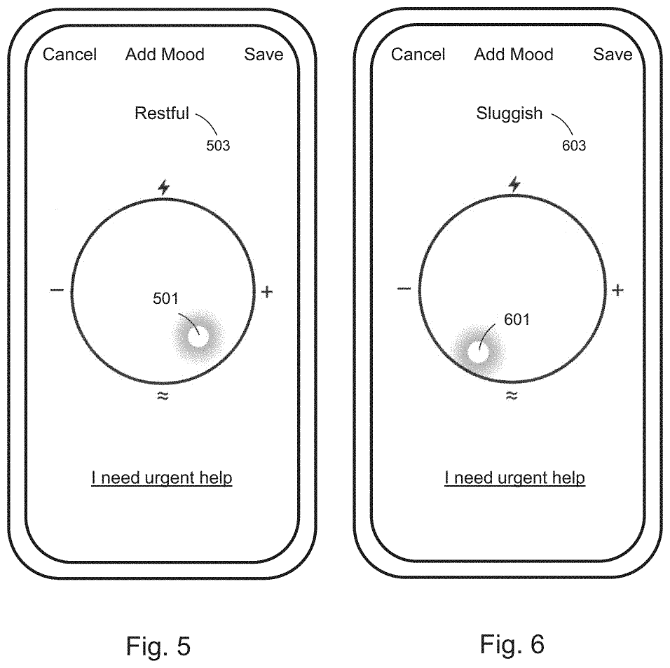

An example of how the first and second values (the “trend data”) are determined from the mood chart will now be described. Here, we will assume that 100% positivity lies in the middle of the furthest segment on the x-axis, as shown in FIG. 7. The values are independent of the size of the central portion of the chart.

For a given mood descriptor, we can determine (R,T), the polar coordinate corresponding to the centroid of the mood descriptor relative to the centre of the mood chart where:
the radius R can only take values {R₁, R₂, R₃, R₄} corresponding to the rings
   Rₙ₊₁=Rₙ+d=Rₙ+[(R₄−R₁)/3]
   R₄=1
   The angle T is measured counter-clockwise from the x-axis

The trend values p and e, for positivity (x-axis) and energy (y-axis), respectively, are given by:

p=(R cos(T)+1)/2

e=(R sin(T)+1)/2

It will be noted that the addition of the integer 1, and the subsequent division by 2 in the above equations means that the values for p and e vary in the range [0, 1], rather than [−1, 1].

If T is calculated clockwise from the y-axis, then:

p=(R sin(T)+1)/2

e=(R cos(T)+1)/2

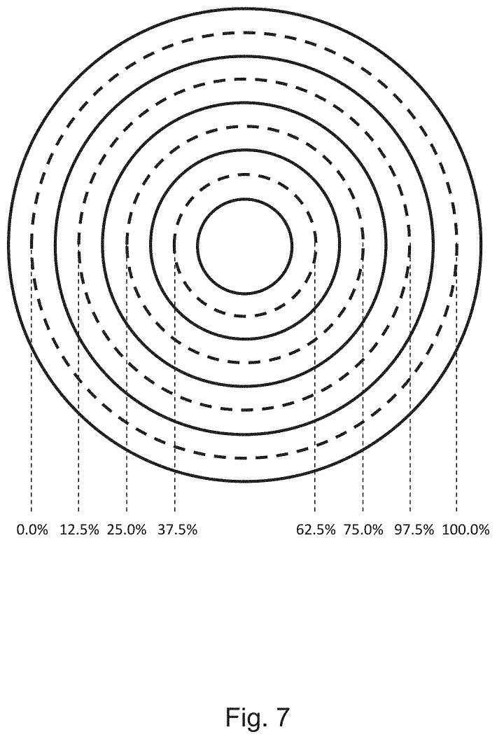

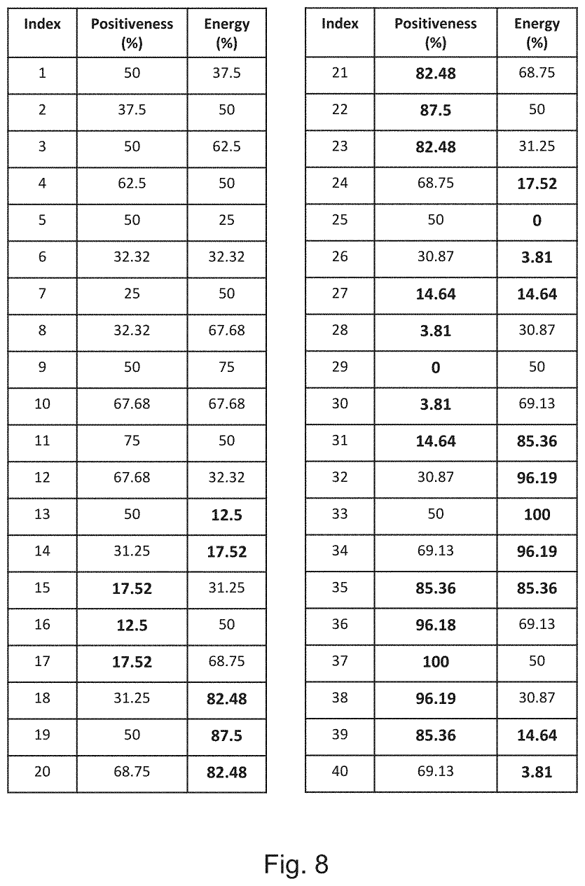

FIG. 8 shows a table of value for each one of the mood descriptors in the mood chart, when taking the radius of the 4 rings of the mood chart to be {0.25, 0.5, 0.75, 1.00}. Note that the values p and e, which lie in the range [0,1] have been converted to percentages in the table. The indices of the respective mood descriptors are shown in FIG. 9.

We can also calculate the trend values from mood co-ordinates. In this case, we use the exact coordination location to provide the trend values. Here, 100% positivity/energy will lie on the far edge of the circle.

Given:
Rᵢ is the radius of the central empty area of the mood chart
Rₒ is the radius of the entire mood chart
aᵢ is the trend value of the central empty area (0≤aᵢ≤1)
(X,Y) the Cartesian co-ordinates of a mood descriptor relative to the centre
   the centre is at (0,0)
         |X|≤1
         |Y|≤1
aᵣ is the trend value of the ring area, where aᵣ=1−aᵢ

Such that:
Rᵢ maps onto a,
(R₀−Rᵢ) maps onto aᵣ

In this case, the trend values for positivity (x-axis) and energy (y-axis) are given by:

p=(aᵣ[(X−Rᵢ)/(R₀−Rᵢ)]+aᵢ+1)/2

e=(aᵣ[Y−Rᵢ)/(R₀−Rᵢ)]+aᵢ+1)/2

As before, the addition of the integer 1, and the subsequent division by 2 in the above equations means that the values for p and e vary in the range [0, 1], rather than [−1, 1].

By resolving the mood into two components along different axes, embodiments described herein can provide greater insight into how a person's mood varies over time and help to identify underlying changes that might otherwise be missed if using a simple one-dimensional assessment of the person's mood.

In some embodiments, the trend values as determined by the computing device may be compared against a threshold. In more detail, the value on the energy axis may be compared against one or more thresholds for the energy axis, and the value on the positivity axis may be compared against one or more threshold for the positivity axis. In one example, each value may be compared against both a 20% (low) threshold and an 80% (high) threshold. Using an 80% threshold for high and 20% threshold for low would mean that the furthermost two rings of the mood model would be categorised as high or low. Referring again to FIG. 8, the entries in the table that are present in bold indicate a metric (energy or positivity) which has passed the threshold (higher than 80% or lower than 20%). Referring to FIG. 9, moods for which the descriptor is in bold (first two rings of the model) would have neither energy nor positivity passing the high/low threshold. Moods that are underlined have both energy and positivity passing the high/low threshold.

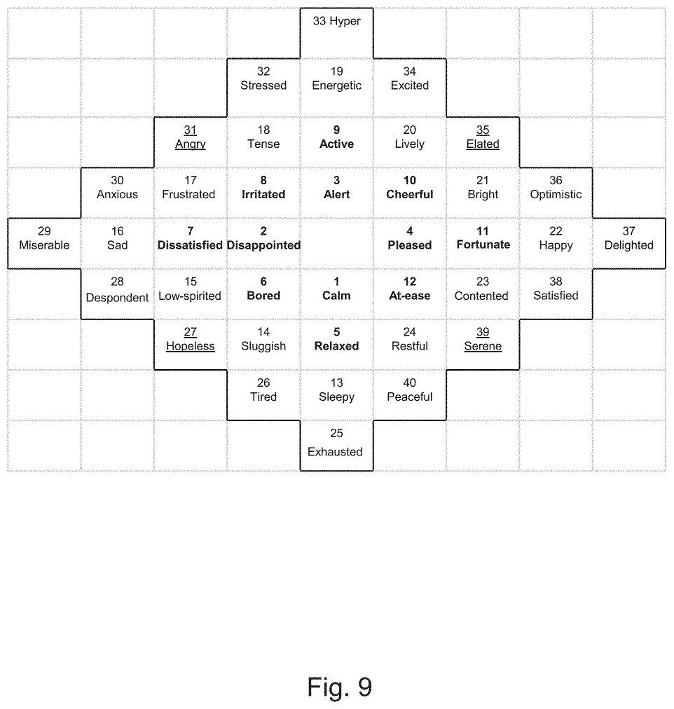

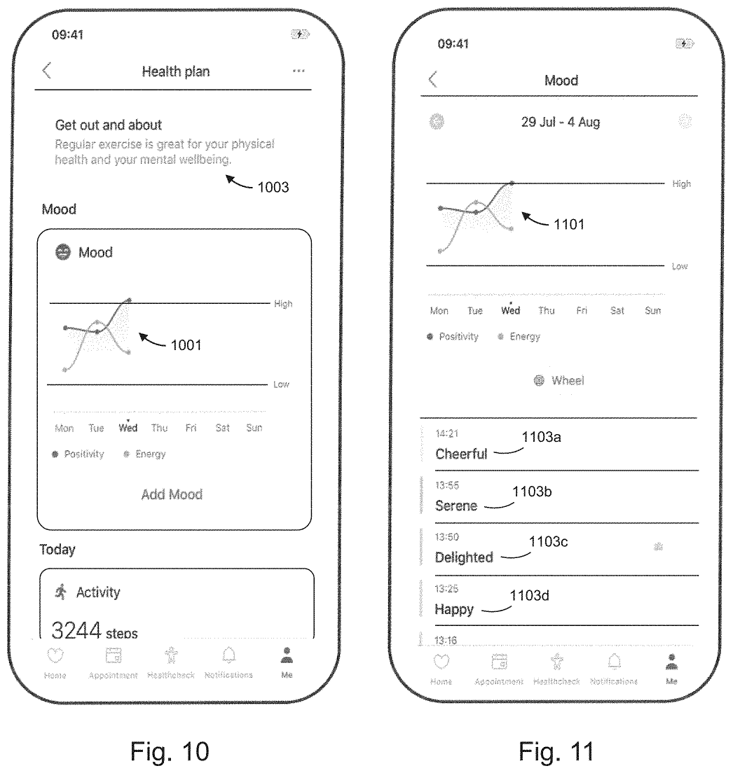

Having determined the trend values p and e for the mood descriptor selected from the mood chart by the user, the trend values can be stored in memory and plotted alongside trend values determined at previous points in time to build up a profile of the user's change in mood over time. FIGS. 10 and 11 show example displays as might be shown on the screen of the computing device following the determination of the trend values. In addition to the trend data 1001, the graphs also display the high and low thresholds discussed above. In FIG. 10, the display shows how the values on the positivity and energy axes vary over time, together with a relevant suggestion 1003 for helping to improve the user's mood, which in the present case comprises a suggestion to take more physical exercise. FIG. 11 shows a more in-depth breakdown of the user's mood data 1101, with both the trend data and the most recently selected mood descriptors 1103a-d being presented. Each mood descriptor is accompanied by a timestamp that shows the time of day at which the mood descriptor was selected by the user.

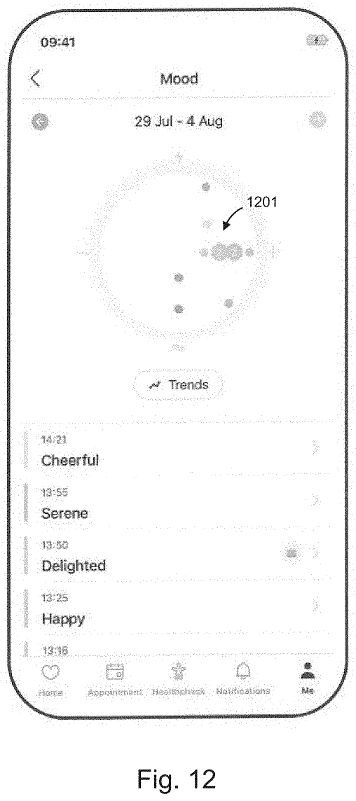

FIG. 12 shows another view as may be displayed on the screen of the user interface. Here, the spots 1201 in the control panel circle reflect the positions of recently selected mood descriptors, in effect building up a heat-map of the regions of the mood chart to which the user most often tends to navigate. The view in FIG. 12 provides a useful graphic for helping the user to understand whereabouts in the energy/positivity space they tend to be most of the time.

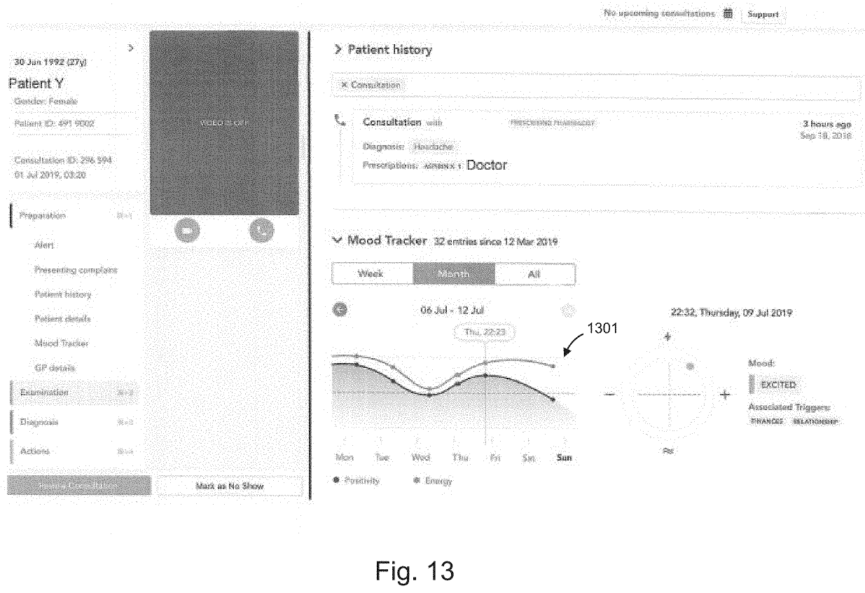

In addition to allowing the user to view their own personal trend data, embodiments can also provide for transmitting the data to a remote location or server. For example, it may be helpful for a medical professional or counselor to have access to the data, in order to monitor the mental well-being of a patient, possibly in conjunction with any physical symptoms the patient is experiencing and/or any medication that they have been prescribed. When sending the data, the data may be encrypted in order to protect the privacy of the user. FIG. 13 shows an example of a patient's medical record as might be viewed by such a medical professional or clinician. In addition to providing details about the user's medical condition and current prescriptions, the display also includes the mood trend data 1301 as collected by the user on their personal computing device. The medical professional is able to view the values recorded on both the positivity and energy axes. By presenting data in this format, the medical professional can obtain a better insight into the patient's frame of mind and use this to consider and propose courses of action that might not otherwise have occurred to them and which might offer a better overall result in terms of the patient's mental as well as physical well-being. Importantly, the medical professional may be able to pick up on any worrying signs more quickly, which the patient may not have otherwise expressed to the professional. For example, it might become evident from the trend data that the patient is becoming very depressed, and some form of intervention may be necessary to ensure the patient has the support they require.

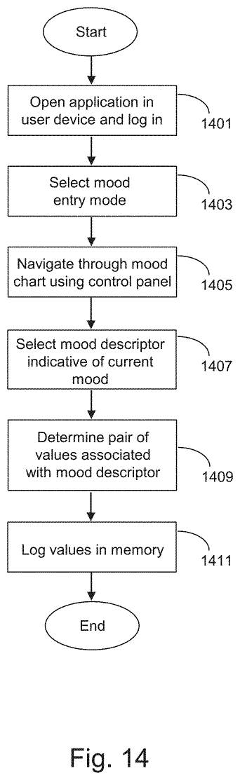

FIG. 14 shows a flow-chart of steps carried out when using the device to log a user's mood at a particular moment in time. In step 1401, the user opens the application on their device. The user may optionally log-in to the application, by entering a username and/or password, for example. In step 1403, the user selects the “mood entry” mood by selecting the option to “Add Mood” from the options bar on the screen. In step 1405, the user uses the control panel to navigate across the mood wheel and find a mood descriptor that most accurately captures their current mood. In step 1407, the user selects the mood descriptor from the mood wheel. In step 1409, the processor of the computing device uses the selected mood descriptor and its position in the mood chart to determine values on both the energy and positivity axes. In step 1411, the determined values are logged in memory, together with the time and/or date at which the user selection was made.

It will be appreciated that whilst the specific embodiments discussed above have focussed on energy and positivity as suitable metrics for assessment of mood, embodiments are not confined to these metrics only. Indeed, a number of different metrics may be used for the trend data. As one example, by rotating the mood chart of FIG. 2, it would be possible to define the mood axes as an “anxiety” axis, and a “depression” axis, rather than a “positivity” axis and “energy axis”, without having to alter the position of the mood descriptors in the chart. In other examples, the positioning of the mood descriptors in the chart could be adapted to enable the definition of alternative sets of orthogonal axes. Such alternatives sets of axes may include:
pleasantness vs engagement
negative affect vs positive affect
tension arousal vs energy arousal
conducive/obstructive vs power/control

In some examples, when entering a particular mood, the device may provide the user with the opportunity to add notes to be stored in memory and which may provide further background to how they came to be feeling the way they do at the present time. The user may have the opportunity to store photos or other multimedia items in association with the mood entry. The information stored in this way can provide a useful indication of the sorts of experiences that may trigger the user to experience a particular mood.

In some embodiments, the computing device may offer the user the ability to view the mood chart 201 on the screen. Where this is the case, the mood chart may be colour coded, so that the annular sectors for mood descriptors indicative of sad emotions may be blue, for example. As an example, in the mood wheel shown in FIG. 2, the annular sectors for moods associated with happy or content emotions may be a more neutral colour such as green, and those associated with angry emotions may be coloured red. The colours of each annular sector may be chosen so that as one moves radially out from the centre, the colours become deeper, in keeping with the greater intensity of the moods depicted in each successive ring of the mood wheel. As one moves circumferentially around the wheel, the colours of each annular sector may gradually transition from one colour to another. So, for example, as one moves circumferentially from the “low spirited” to “contented”, one may move from purple annular sectors, through blue annular sectors, into turquoise annular sectors and finally into green annular sectors.

It will be appreciated that whilst the mood chart in the embodiments described above comprises a circular wheel, the mood chart may take one of any number of different spatial formats, including, for example, a star or triangle. The chart may also be presented as a 3D object, such as a cube or pyramid, that is rotatable to display different faces displaying different mood descriptors.

It will be further appreciated that whilst the above described embodiments employ a touch-sensitive control panel for selecting different mood descriptors, the user-input may take other forms. For example, users can log their mood by using their voice, with the computing device employing voice recognition software to recognise a mood descriptor spoken by the user. As before, the device may then identify the values associated with that mood descriptor on the mood axes by reference to the mood chart before storing those values in memory.

Embodiments described herein provide a means by which users can easily and effectively log their mood at different points in time. Users are offered a quick and intuitive way to define their dominant mood whilst still being able to choose from a large number of different mood descriptors to get a precise view of their mood at any given time. In particular, embodiments obviate the need to display a large volume of data on the screen at any one moment in time, thereby ensuring that the mood descriptors can be displayed at a high enough level of resolution. At the same time, embodiments prevent the user from being overwhelmed, or put off, by being presented with a large number of possible options to choose from all at once.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A computing device for logging changes in a person's mood over time, the device comprising:
a user interface for receiving a user-input indicative of the user's mood at a current point in time;
a processor configured to determine a pair of values associated with the user-input, wherein a first value in the pair of values defines a position on a first mood axis, and the second value in the pair defines a position on a second mood axis, the first and second mood axes being associated with different aspects of mood; and
a memory for storing the pair of values together with an indicator of a current point in time,
the processor being further configured to compare the pair of values with one or more other pairs of values obtained at respective points in time, thereby to generate trend data reflecting one or more trends in the values over time;
wherein the computing device stores a predetermined threshold value;
wherein, for each pair of values, the processor is configured to determine if one or both of the values lie above or below the predetermined threshold value; and
wherein the computing device is configured to display the trend data and the predetermined threshold value to the user.

2. A computing device according to claim 21, wherein the first mood axis defines a level of energy associated with the selected mood descriptor, and the second mood axis defines a level of positivity associated with the selected mood descriptor.

3. (canceled)

4. A computing device according to claim 21, wherein the device is configured to transmit the trend data to a remote device or server.

5. A computing device according to claim 21, wherein the user interface comprises a control panel for navigating to different regions of a mood chart, the mood chart comprising a plurality of mood descriptors arranged in a spatial layout, each mood descriptor representing a different mood that a user may be experiencing at a particular point in time.

6. A computing device according to claim 5, wherein the mood descriptors in the mood chart are arranged such that navigating in a first direction in the mood chart causes the user to move along the first mood axis and navigating in a second direction in the mood chart causes the user to move along the second mood axis.

7. A computing device according to claim 5, wherein as the user navigates the mood chart, the user interface is configured to display a subgroup of the mood descriptors from the mood chart, the subgroup of mood descriptors comprising one or more mood descriptors associated with the region of the mood chart to which the user has currently navigated.

8. A computing device according to claim 7, wherein the subgroup of mood descriptors comprises a single mood descriptor only.

9. A computing device according to claim 8, wherein the single mood descriptor is the only part of the mood chart that is displayed in the user interface.

10. A computing device according to claim 9, wherein the single mood descriptor is displayed as a title in the user interface.

11. A computing device according to claim 10, wherein the control panel comprises a defined area of the user interface, the user being able to select different points from within the area of the control panel, the user device being configured to perform a mapping between points within the area and positions on the mood chart so as to map the selected position within the area to a position on the mood chart.

12. A computing device according to claim 11, wherein the control panel is displayed on a screen of the computing device, the device being configured to display a marker at the point in the area selected by the user.

13. A computing device according to claim 12, wherein the user interface comprises a touch screen, and the user is able to select different points within the area by touch.

14. A computing device according to claim 12, wherein the marker comprises an inner section and an outer surround, the outer surround being colour-coded based on the mood descriptor associated with the position on the mood chart to which the selected point is mapped,
wherein in the event the user chooses to log in memory the mood descriptor that is associated with the position on the mood chart to which the selected point in the control panel is mapped, the user device is configured to colour the inner section of the marker with the colour of the outer surround.

15. A computing device according to claim 5 wherein the mood chart is a circular wheel; and
optionally wherein the wheel comprises a plurality of annular rings, each ring having one or more annular sectors, each mood descriptor being located in a respective one of the annular sectors.

16. A computing device according to claim 5, wherein the processor is configured to determine the pair of values associated with the selected mood descriptor by determining a set of polar or Cartesian coordinates for the position of the mood descriptor on the mood chart.

17. A computing device according to claim 1, wherein the computing device is configured to store additional media content in association with the selected mood descriptor.

18. A computing device according to claim 17, wherein the additional media content includes one or more of: notes, images, videos and audio clips provided by the user.

19. A computer-implemented method for logging changes in a person's mood over time, the method comprising:
receiving a user-input indicative of the user's mood at a current point in time;
determining a pair of values associated with the user-input, wherein a first value in the pair of values defines a position on a first mood axis, and the second value in the pair defines a position on a second mood axis, the first and second mood axes being associated with different aspects of mood;
storing the pair of values together with an indicator of a current point in time; and
comparing the pair of values with one or more other pairs of values obtained at other points in time, thereby to determine trend data reflecting one or more trends in the values over time;
wherein the computing device stores a predetermined threshold value;
wherein, for each pair of values, a determination is made as to whether one or both of the values lie above or below the predetermined threshold value; and
wherein the computing device is configured to display the trend data and the predetermined threshold value to the user.

20. A non-transitory computer-readable storage medium comprising computer executable instructions that when executed by a computer will cause the computer to carry out a method comprising:
receiving a user-input indicative of the user's mood at a current point in time;
determining a pair of values associated with the user-input, wherein a first value in the pair of values defines a position on a first mood axis, and the second value in the pair defines a position on a second mood axis, the first and second mood axes being associated with different aspects of mood;
storing the pair of values together with an indicator of a current point in time; and
comparing the pair of values with one or more other pairs of values obtained at other points in time, thereby to determine trend data reflecting one or more trends in the values over time;
wherein the computing device stores a predetermined threshold value;
wherein, for each pair of values, a determination is made as to whether one or both of the values lie above or below the predetermined threshold value; and
wherein the computing device is configured to display the trend data and the predetermined threshold value to the user.

21. A computing device according to claim 1, wherein the user-input comprises a selection of one of a plurality of mood descriptors.
